(19) United States
(12) Patent Application Publication
(10) Pub. No.: US 2015/0312411 A1
(43) Pub. Date: Oct. 29, 2015

(54) METHOD FOR DIRECTING A PHONE CALL TO A WEB-BASED MENU ACCESS POINT VIA A PASSIVE TELEPHONE ACCESS POINT

(71) Applicant: aProlix Systems, Inc., Stanford, CA (US)

(72) Inventors: Victor A. Miller, II, Menlo Park, CA (US); Krystian K. Maskos, Houston, TX (US); Alejandro J. De Simone, Stanford, CA (US)

(73) Assignee: APROLIX SYSTEMS, INC., Stanford, CA (US)

(21) Appl. No.: 14/694,724

(22) Filed: Apr. 23, 2015

Related U.S. Application Data
(60) Provisional application No. 61/983,150, filed on Apr. 23, 2014.

(51) Int. Cl. H04M 3/493; H04M 3/58

(52) U.S. Cl. CPC H04M 3/4931; H04M 3/58

(57) ABSTRACT

A method for providing interactive voice response (IVR) includes providing, by an IVR telephone system, to a telephone caller connected to the IVR telephone system, an auditory prompt informing the user of the availability of a visual menu system useable in lieu of the IVR telephone system. The caller is forwarded, by the IVR telephone system, to a passive telephone access point (PTAP). A notification is sent, by the PTAP, to the caller via a communication channel distinct from the voice communication channel via which the caller connected to the IVR telephone system. The notification includes information for directing the caller to connect to the visual menu system. The caller connects to the visual menu system using the information provided in the notification.

### CROSS-REFERENCE TO RELATED APPLICATIONS

This application claims benefit of priority to U.S. Provisional Patent Application Ser. No. 61/983,150, filed Apr. 23, 2014, entitled “Method for Directing a Phone Call to a Web-based Menu Access Point via a Passive Telephone Access Point,” which is hereby incorporated herein by reference in its entirety.

### BACKGROUND

1. Field of the Disclosure

The present disclosure relates to an interactive voice response (IVR) system and more specifically to a system and method for providing access to a visual menu system from an IVR system.

2. Background of the Technology

Interactive voice response (IVR) systems are used to handle a large number of phone calls, or to provide callers with information (e.g., hours of operation) that can be delivered without interacting with a human operator. IVR systems primarily interact with callers via spoken prompts or numerical-pad inputs, and are therefore referred to as audio-based or audio-interfaced IVR systems. Visual-based menus for IVR systems, which present the caller with the same information delivered from the audio-based IVR, but in visual format, increase the ease with which the caller can digest and interact with the IVR.

IVR systems allow a business, organization, or establishment to automatically interact with a human user (e.g., a user or caller). A typical IVR experience involves a user dialing the telephone number of an organization that provides IVR for calls made to the organization and the IVR system answering the call. The user may then be presented with options for direction via spoken prompts and asked to choose an option by dialing a number (e.g., “Press 1 for sales”) or by asking the user to speak their choice (“Say ‘sales’ to be connected with a sales representative”). Depending on the user's choice, the user may then be placed on hold until the next available agent associated with the organization is able to speak to the user.

IVR systems with only an audio interface may provide multiple levels of menus and may be able to receive a variety of inputs, including data such as credit card numbers, account numbers, or dates of birth. IVR systems, in general, are implemented to provide information to users (e.g., operating hours), connect users with support representatives, and/or function as a directory. In some cases, IVR systems may also be able to queue users and connect users to entities in the business in the order in which they call, such as at a customer support call center.

### SUMMARY

The following presents a simplified summary of various aspects of the claimed subject matter in order to provide a basic understanding of such aspects. This summary is not an extensive overview of all contemplated aspects, and is intended to neither identify key or critical elements nor delineate the scope of such aspects. Its sole purpose is to present some concepts of the disclosed aspects in a simplified form as a prelude to the more detailed description that is presented later.

An interactive voice response (IVR) system that provides a novel method to direct callers from a conventional IVR system to a menu access point that provides a visual menu for customer service (CS) and customer relationship management (CRM) systems is disclosed herein. A menu access point is an interactive, visual-interface on a smart-phone or computer based device that complements or enhances the functionality of the existing IVR system. Redirection from the conventional IVR to the visual menu is provided via a passive telephone access point (PTAP). The PTAP is universally compatible with existing CS and CRM IVR systems, and moves the caller interaction from a purely audio-based interaction to an interactive, visual-interface on a smart-phone or computer. The PTAP facilitates data input into the CRM system, providing an improved experience for both the phone caller and the customer support representative.

### BRIEF DESCRIPTION OF THE DRAWINGS

For a detailed description of exemplary embodiments of the invention, reference will now be made to the accompanying drawings in which:

FIG. 1 illustrates an interactive voice response (IVR) system that includes a passive telephone access point (PTAP) in accordance with certain aspects of the present disclosure;

FIGS. 2A-2C illustrate menu access for customer service or customer relationship management in accordance with certain aspects of the present disclosure;

FIG. 3 illustrates a flow diagram of an example methodology for call handing in an IVR system in accordance with certain aspects of the present disclosure; and

FIG. 4 illustrates deployment of multiple PTAPs in accordance with certain aspects of the present disclosure.

### NOTATION AND NOMENCLATURE

In the following discussion and in the claims, the terms “including” and “comprising” are used in an open-ended fashion, and thus should be interpreted to mean “including, but not limited to . . . .” In addition, the term “couple” or “couples” is intended to mean either an indirect or a direct connection. Thus, if a first device couples to a second device, that connection may be through a direct connection, or through an indirect connection accomplished via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of other factors.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Switching from an audio-based interactive voice response (IVR) system to a visual-based IVR system may be associated with extremely high switching costs. This is due to the fact that IVR systems typically require significant investment in hardware to properly handle incoming calls and correctly route them to the appropriate operator. Additionally, the creation of a visual menu to accurately represent the entire functionality of an existing audio-based IVR involves significant risk due to the familiarity of customers with the audio-based system. Thus, aspects of the present disclosure provide techniques for directing callers away from a traditional IVR system to an enhanced visual customer service (CS) and/or customer relationship management (CRM) solution that may complement an existing audio-based IVR system.

Aspects of the present disclosure provide techniques for directing a caller to a menu access point that may provide a visual menu (e.g., through deployment of a passive telephone access point (PTAP)). The PTAP system disclosed herein may provide callers with access to an enhanced (visual) CS and/or CRM solution that may allow an IVR operator to direct callers away from their existing IVR to a menu access point. According to certain aspects, the menu access point may be accessed via a computing platform (e.g., a desktop computer or laptop), mobile devices (e.g., a smartphone or tablet), and/or other computer-based devices. The menu access point may enable access to personal information (e.g., personal accounts) and/or billing information through the use of databases that may be associated with a PTAP corresponding to the menu access point.

According to certain aspects, information regarding the menu access point (e.g., its style and content) and/or information regarding a caller and their history interacting with a PTAP may be stored in one or more databases associated with the corresponding PTAP. In some cases, a caller's history may then be used to drive CRM decisions and also ported into existing CRM solutions.

According to certain aspects, the menu access point may be a web-based interface, mobile-smartphone or tablet application-based interface, and/or an interface built into an operating system of the smartphone, tablet, or computer to supplement or replace audio-based IVR systems. According to certain aspects, the PTAP may allow existing IVR systems to interface with such a menu access point.

Aspects of the present disclosure also provide techniques for rapidly and automatically deploying PTAP systems and the database infrastructure to support the PTAP and its corresponding menu access point. In some cases, a PTAP may connect a caller using an existing IVR system to a corresponding menu access point, for which the appearance and content provided to the caller may be determined by an operator of the menu access point, as noted above. Aspects of the present disclosure provide detail about the type of databases that may be automatically deployed upon creation of a new PTAP, and how the databases store information regarding the PTAP, the menu access point, and a log of callers.

The present disclosure describes a system and method for directing a caller engaged with a conventional IVR system to a complementary menu access point. The menu access point may be hosted on a remote server, and may be accessible via a web-browser, mobile-application, or integrated operating system feature. The redirection of the caller may be accomplished, for example, via deployment of a passive telephone access point. The PTAP may be a listening service hosted on remote server that, upon being triggered, sends a message to the caller, directing the caller away from a traditional IVR to the menu access point. In some cases the message may be sent on a different communication channel (e.g., a push notification, a text message, an email, etc.) than the communication channel via which the user is connected to the IVR. The PTAP can be interfaced with conventional IVR systems, so long as the IVR can forward a call with a caller identification number corresponding to the caller.

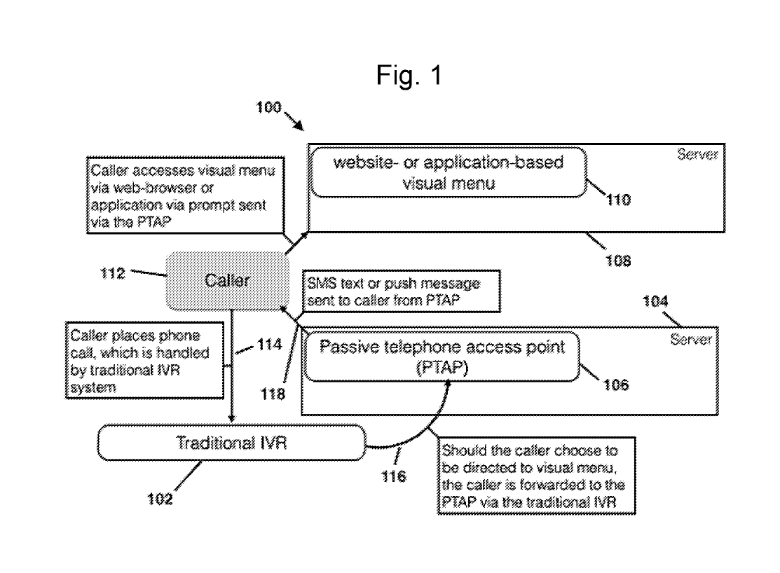

FIG. 1 illustrates an IVR system 100 that may include a PTAP in accordance with various embodiments. The IVR system 100 may include a conventional IVR 102, a server 104 that may include a PTAP 106, and a server 108 that may provide a visual menu 110. According to certain aspects, the conventional IVR 102 may provide audio based interaction with the caller 112, but may be incapable of providing visual interaction with the caller 112. While illustrated separately, the IVR 102, server 104, and server 108 may be housed within a same server.

According to certain aspects, the server 104 may include a computer (e.g., a desktop computer, a rack-mount computer, or other computing device suitable for providing the PTAP functionality disclosed herein). In some cases, a computer suitable for providing PTAP functionality may include a processor and storage, and may include a display device, an input device, and miscellaneous interfaces. The processor may be communicatively coupled to the storage, the display device, the input device, and the miscellaneous interfaces. The processor may be a general-purpose microprocessor, a digital signal processor, a microcontroller, or other device capable of executing instructions retrieved from a computer-readable storage medium. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

According to certain aspects, the storage may be a non-transitory computer-readable storage medium suitable for storing instructions that are retrieved and executed by the processor to perform the functions disclosed herein (e.g., the PTAP functions). The storage may include volatile storage such as random access memory, non-volatile storage (e.g., a hard drive, an optical storage device (e.g., CD or DVD), FLASH storage, read-only-memory), or combinations thereof.

The miscellaneous interfaces coupled to the processor may include various network adapters that allow the server 104 to communicate with the IVR 102, the server 108, and/or the caller 112 via wired networking, wireless networking, cellular telephone/data networking, and/or other suitable communication systems.

According to certain aspects, the processor may execute instructions stored in and retrieved from the storage to perform the various functions disclosed herein. The instructions stored in the storage include instructions for providing PTAP functionality. Accordingly, a PTAP may include a computer and the PTAP instructions that cause the processor of the computer to perform the PTAP functions when executed. The PTAP as referred to herein may include the processor and instructions executed by the processor to provide PTAP functionality.

The server 108 may be similar to the server 104, and includes a computer having a processor, storage and other components as described with regard to the server 104. The storage of the server 108 includes instructions that when executed cause the processor to perform the functions associated with the visual menu 110.

According to certain aspects, as noted above, the PTAP 106 may provide a listening service that, upon being triggered, sends a message, via a different communication channel (e.g., SMS text message, push notification, email, etc.), to the caller 112. According to certain aspects, the message may direct the caller 112 to the menu access point 110.

FIG. 1 illustrates an exemplary process of redirecting a caller 112 from the IVR 102 to the visual menu 110 via the PTAP 106. For example, the caller 112 may place a telephone call 114, which may be answered by the conventional IVR 102. The IVR 102 may then present the caller 112 with several auditory options. According to certain aspects, one such auditory option may be an option for the caller 112 to be directed to the visual menu 110. According to certain aspects, if the caller chooses to be directed to the visual menu 110 (e.g., via voice prompt, telephone keypad entry, etc.) the IVR 102 may forward the call 116 to the PTAP 106, which, in some cases, has its own, unique telephone number.

According to certain aspects, the PTAP 106 may utilize a “cloud-based” telecommunications API (or a remote IVR) that may provide web-based and computer-based interaction with conventional telephone systems. According to certain aspects, the PTAP 106 may then receive the phone call 116 forwarded by the IVR 102 and may send a message 118 (e.g., a text message, push notification, or other suitable notification) to the caller 112. On receipt of the message 118 from the PTAP 106, the caller 112 may follow a link or notification provided in the message 118 to access the visual menu 110 corresponding to the PTAP 106.

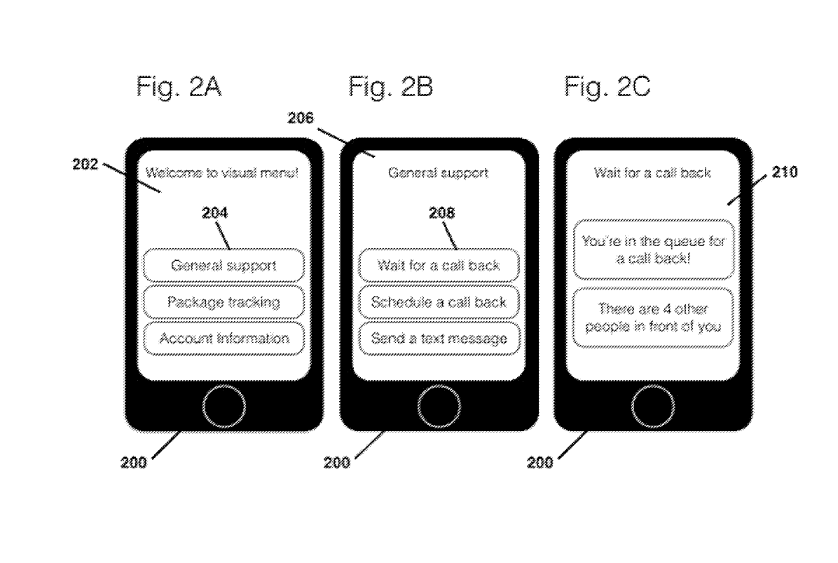

FIGS. 2A-2C illustrate example visual menus provided on a user computing device 200 (e.g., a smartphone, a tablet computer, a notebook computer, or other suitable computing device) responsive to a PTAP notification, such as may be provided by the PTAP 106.

According to certain aspects, FIG. 2A may assume a scenario in which the caller 112 has received, from the PTAP 106, a notification comprising a link to a visual menu and the user computing device 200 has established a connection with the visual menu 110 (e.g., via the internet).

According to certain aspects, the visual menu 110 of FIG. 2A may display on the user computing device 200 an initial menu 202 (e.g., a welcome menu) that may provide various options from which the user may select. As one example, the visual menu 110 may provide a general support option, a package tracking option, and/or an account information option. It should be noted that the options shown in FIG. 2A are only exemplary, and other embodiments of the visual menu 110 may provide different options.

As noted above, the visual menu 110 may comprise a General Support option 204, which may be provided in an initial menu 202 of FIG. 2A.

FIG. 2B illustrates an exemplary General Support menu 206 that may be displayed on the device 200. The General Support menu 206 may be provided by the visual menu 110 responsive to the caller 112 selecting General Support option 204 as shown in FIG. 2A. The General Support menu 206 may provide various options from which the user may select. For example, the General Support menu 206 may provide a “Wait for call back” option 208, a “schedule a call back” option, and/or a “send a text message” option. According to certain aspects, upon a caller 112 selecting the “Wait for call back” option 208, the caller may be presented with a “wait for call back” menu 210.

FIG. 2C illustrates an exemplary “wait for call back” menu 210 provided on the user computing device 200. According to certain aspects, the “wait for call back” menu 210 may provide information, for example, indicating when the caller 112 may receive a return call from a customer service agent. It should be noted that the information shown in FIG. 2C is only exemplary, and other embodiments of the visual menu 110 may provide different information.

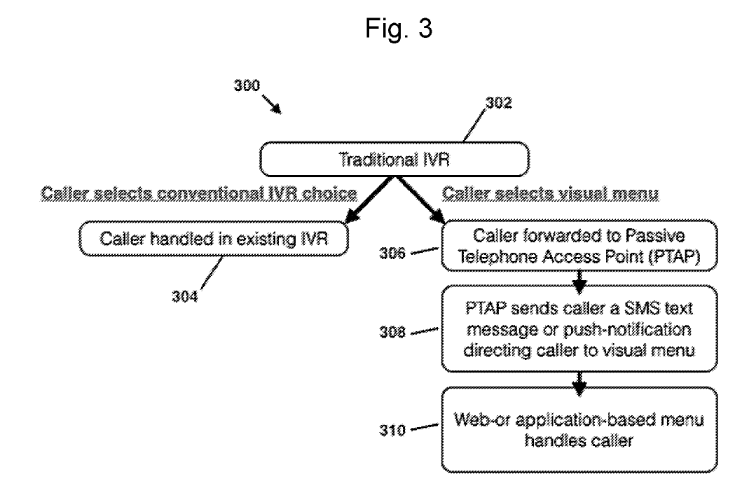

FIG. 3 illustrates example operations 300 for call handing in an IVR system in accordance with various embodiments. Operations 300 begin at 302, with a caller being connected with a traditional IVR 102. According to certain aspects, the IVR 102 may auditorily present the caller 112 with the option of being directed to the PTAP 106 (i.e., being directed to the visual menu 110).

At 304, the caller may decline the offer to be connected to the visual menu 110, and the IVR 102 may direct the caller 112 using conventional auditory prompting.

At 306, the caller 112 accepts the offer to be connected the visual menu 110, and the IVR 102 forwards the call to a telephone number corresponding to the PTAP 106.

At 308, the PTAP 106 receives the call forwarded by the IVR 102. According to certain aspects, upon receiving the forwarded call, the PTAP 106 sends a notification (e.g., an SMS text message, a push notification, an email, etc.) to the caller 112. The notification may provide a link (e.g., a URL), that directs the caller 112 to a web- or application-based menu access point, such as the visual menu 110.

At 310, the caller 112 may follow the link to access and interact with the visual menu 110 displayed the user computing device 200. According to certain aspects, the visual menu 110 may be intended to enhance the IVR customer-service experience for users calling from a mobile device that contains a screen, web-browser, and the ability to run (or execute) applications.

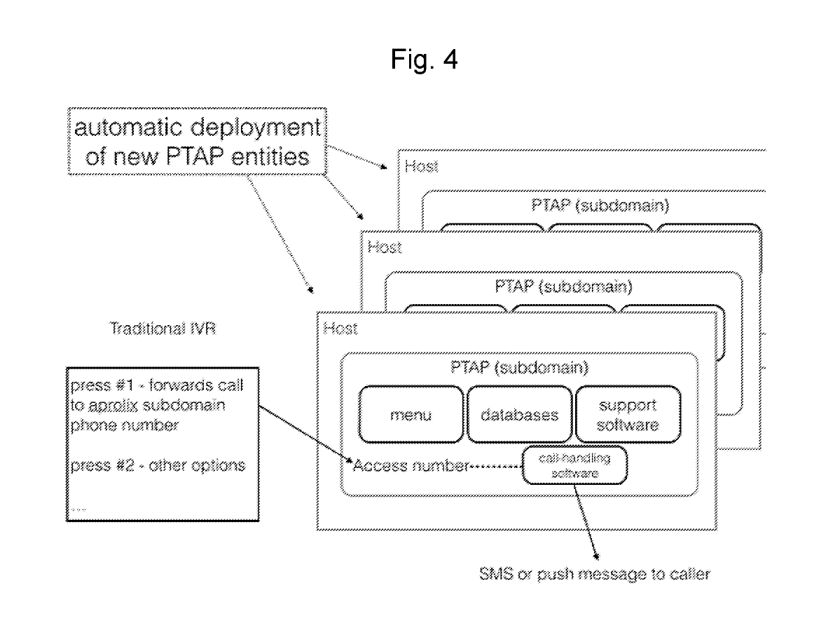

FIG. 4 illustrates an example deployment of multiple PTAPs in accordance with various aspects of the present disclosure. As explained with regard to the PTAP 106, each PTAP may be hosted on a server (sometimes referred to as the PTAP server), which may serve an instance of a web-based telecommunications protocol capable of handling incoming phone calls. According to certain aspects, PTAPs may be automatically deployed by creating an instance of a PTAP on a server, and establishing a unique phone number for that PTAP (e.g., the “access number” in FIG. 4). The unique access number may be the number to which a conventional IVR (e.g., IVR 102) forwards a caller should the caller desire to be directed to the visual menu.

According to certain aspects, each PTAP may include instructions (i.e., call-handling software) that may cause a processor to handle calls forwarded by the conventional IVR. The call-handling software may send the caller a notification (e.g., an SMS text message, push notification, email, etc.) containing information (e.g., a URL) directing the caller to the appropriate visual menu (i.e., the visual menu associated with the PTAP). According to certain aspects, in the deployment of a single PTAP instance, the instantiation of the access number and the call-handling software may be automatically handled by a PTAP deployment system (e.g., a computer configured to automatically deploy PTAPs), which may be done with or without input from a deploying user or administrator. In some cases, if inputs are not provided, default values for the access number and call-handling software may be used. According to certain aspects, a PTAP may be deployed automatically in response to a new user signing up for the PTAP service, or, in some embodiments, a PTAP administrator may need to approve each new deployment of a PTAP. Automatic deployment may also include deployment of the databases, HTML, and other scripts, functions, or software associated with the menu access point (e.g., the visual menu 110). A single server or virtual server may be dedicated to hosting a single PTAP, or a single server may host multiple PTAPs, so long as each PTAP has its own unique, access number.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for providing interactive voice response (IVR), comprising:
providing, by an IVR telephone system, to a telephone caller connected to the IVR telephone system, an auditory prompt informing the user of the availability of a visual menu system useable in lieu of the IVR telephone system;
forwarding, by the IVR telephone system, the caller to a passive telephone access point (PTAP);
sending, by the PTAP a notification to the caller via a communication channel distinct from the voice communication channel via which the caller connected to the IVR telephone system, the notification comprising information for directing the caller to connect to the visual menu system;
connecting the caller to the visual menu system using the information provided in the notification.

2. The method of claim 1, wherein the caller is connected to a data network via a smart telephone, a tablet computer, a laptop computer, or another mobile device.

3. The method of claim 2, wherein the visual menu system is hosted on a server and accessible via the internet or a data-based connection, installed as an application on a mobile platform or tablet, or innate to the operating system of the mobile or tablet device;

4. The method of claim 1, wherein the information comprises a hypertext link sent to a user via a text message, push notification sent from a host, or a URL accessible via an Internet browser.

5. The method of claim 1, further comprising:
associating a database with the PTAP, the database storing personal information associated with the caller;
retrieving the personal information from the database responsive to the connecting;
providing the personal information to the caller via the visual menu system; and
storing in the database information detailing the caller's interaction with the PTAP and the visual menu system.

6. The method of claim 1, further comprising:
associating a database with the PTAP, the database storing visual menu information that defines the operation and appearance of the visual menu system;
retrieving the visual menu information from the database responsive to the connecting; and
rendering, based on the visual menu information, a visual menu on a device operated by the caller.

7. A system for providing interactive voice response (IVR), comprising:
a computer system comprising:
a passive telephone access point (PTAP) deployment system configured to create a PTAP in association with an IVR telephone system, wherein the PTAP is configured to:
receive telephone calls forwarded by the IVR telephone system;
send a notification to a caller, of a telephone call forwarded by the IVR telephone system, via a communication channel different from a voice communication channel via which the caller connected to the IVR telephone system; wherein the notification comprises connection information that is executable to connect the caller to a visual menu system.

8. The system of claim 7, wherein the PTAP deployment system is configured to, as part of creating the PTAP, create the visual menu system.

9. The system of claim 8, wherein the PTAP deployment system is configured to, as part of creating the visual menu system, create a database that stores content and operational information defining the visual menu system.

10. The system of claim 9, wherein the visual menu system is configured to retrieve content from the database and transmit the content to the caller responsive to the caller accessing the visual menu system via the connection information.

11. The system of claim 7, wherein the notification comprises a text message that includes a hyperlink or a push notification via which the caller connects to the visual menu system.

12. The system of claim 7, wherein the PTAP deployment system is configured to, as part of creating the PTAP, assign a telephone number to the PTAP for receiving the telephone calls forwarded by the IVR telephone system.

13. The system of claim 7, wherein the PTAP deployment system is configured to, as part of creating the PTAP, create a database for storage of personal information of callers of calls forwarded to the PTAP by the IVR telephone system.

14. The system of claim 13, wherein the PTAP is configured to store in the database information regarding the caller and interaction of the caller with the PTAP.

15. The system of claim 14, wherein the visual menu system is configured to provide content to the caller based on the information regarding the caller and interaction of the caller with the PTAP retrieved from the database.

16. A non-transitory computer-readable medium encoded with instructions that when executed cause a computer system to:
deploy a passive telephone access point (PTAP), the deploying comprising:
for each instance of the PTAP deployed:
automatically generating a unique telephone access number for the PTAP;
automatically generating a set of instructions for handling a call forwarded, by an interactive voice response (IVR) telephone system, to the PTAP via the access number;
including in the instructions, information that links the PTAP to a visual menu system to which the PTAP is to direct a caller of a forwarded call.

17. The computer-readable medium of claim 16, encoded with instructions that when executed cause the computer system to: store the instructions in a location of a computer that is dedicated to handling incoming calls.

18. The computer-readable medium of claim 16, encoded with instructions that when executed cause the computer system to include in each PTAP deployed, instructions that when executed send a notification to a caller, of a telephone call forwarded by the IVR telephone system, via a communication channel different from a voice communication channel via which the caller connected to the IVR telephone system; wherein the notification comprises connection information that is executable to connect the caller to a visual menu system.

19. The computer-readable medium of claim 16, encoded with instructions that when executed cause the computer system to, for each instance of the PTAP deployed:
create the visual menu system that is linked to the PTAP.

20. The computer-readable medium of claim 16, encoded with instructions that when executed cause the computer system to, for each instance of the PTAP deployed:
create a first database for storage of personal information of callers of calls that are forwarded to the PTAP by the IVR telephone system;
store in the first database information defining interaction of each of the callers with the PTAP;
create a second database for storage of content and operational parameters of the visual menu system; and
present content of the visual menu system to each of the callers based on the stored information defining interaction with the PTAP.
